(19) United States
(12) Patent Application Publication
(10) Pub. No.: US 2025/0105554 A1
(43) Pub. Date: Mar. 27, 2025

(54) CONNECTOR

(71) Applicant: SUMITOMO WIRING SYSTEMS, LTD., Mie (JP)

(72) Inventor: Kohei TAKAGI, Mie (JP)

(21) Appl. No.: 18/828,580

(22) Filed: Sep. 9, 2024

(30) Foreign Application Priority Data
Sep. 22, 2023 (JP) 2023-158916

(51) Int. Cl. H01R 13/627

(52) U.S. Cl. CPC H01R 13/6273

(57) ABSTRACT

A first connector 10A includes restricting portions 26 configured to elastically deform in a direction to come into contact with one surface P1 of a panel P during a mating process in which the first connector 10A and a second connector 10B are mated together, and a first mating lock portion 27 formed continuously from the restricting portions 26. The second connector 10B includes pressing portions 73 configured to press the restricting portions 26 in the direction to come into contact with the one surface P1 of the panel P during the mating process, and a lock arm 67 configured to elastically deform and disposed separately from the pressing portions 73. The lock arm 67 has a second mating lock portion 69 configured to engage with the first mating lock portion 27.

### CROSS-REFERENCE TO RELATED APPLICATIONS

This application is based on and claims priority from Japanese Patent Application No. 2023-158916, filed on Sep. 22, 2023, with the Japan Patent Office, the disclosure of which is incorporated herein in its entirety by reference.

### TECHNICAL FIELD

The present disclosure relates to a connector.

### BACKGROUND

The connector disclosed in JP 2009-016198 A includes a first connector housing and a second connector housing that can be mated with each other. The first connector housing is held by a panel before the two connector housings are mated together. The first connector housing is provided with an arm portion extending in a cantilevered manner in the mating direction of the two connector housings. Lock portions and a protruding portion are formed on a leading end portion of the arm portion.

In the process in which the two connector housings are mated together, the lock portions climb onto ribs that are formed on the second connector housing and the arm portion is elastically deformed. As a result, the protruding portions face one surface of the panel so that the protruding portions can come into contact with the surface, and the first connector housing is restricted from becoming detached from the panel. Thereafter, the lock portions get over the ribs and the arm portion elastically returns to its original position, and as a result, the lock portions and the ribs are engaged with each other and the two connector housings are held in a mated state. Such a lock structure for a connector positioned on a panel is also disclosed in JP 2008-305695 A, JP H08-078102 A, and JP 2001-283977 A.

### SUMMARY

In the case of JP 2009-016198 A, the ribs need to press the lock portions and thereafter lock the same lock portions, which means that there is a low degree of freedom in terms of their shape. The lock portions also need to have a shape corresponding to the shape of the ribs, and therefore, there is a problem in that it is difficult to reliably maintain the engagement (mating locking) between the lock portions and the ribs.

Therefore, the present disclosure aims to provide a connector that can reliably maintain the mating locking.

A connector according to the present disclosure includes: a first connector; and a second connector configured to be mated with the first connector from one surface side of a panel, wherein the first connector includes a restricting portion configured to elastically deform in a direction to come into contact with the one surface during a mating process in which the first connector and the second connector are mated together, and a first mating lock portion formed continuously from the restricting portion, the second connector includes a pressing portion configured to press the restricting portion in the direction to come into contact with the one surface during the mating process, and a lock arm configured to elastically deform and disposed separately from the pressing portion, and the lock arm has a second mating lock portion configured to engage with the first mating lock portion.

With the present disclosure, it is possible to provide a connector that can reliably maintain the mating locking.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view of a connector according to a first embodiment, excluding first terminal fittings and second terminal fittings.

FIG. 2 is a front view of a first connector housing.

FIG. 3 is a partially enlarged plan view of the first connector housing.

FIG. 4 is a front view of a second connector housing.

FIG. 5 is a plan view of the second connector housing.

FIG. 6 is a partially enlarged cross-sectional view showing a state in which a receiving portion and a release portion are arranged so as to face each other before a first connector and a second connector are mated together.

FIG. 7 is a side view showing a state when the first connector and the second connector start to be mated together.

FIG. 8 is a plan view showing a state when the first connector and the second connector start to be mated together.

FIG. 9 is a side view showing a state of a process in which the first connector and the second connector are mated together.

FIG. 10 is a partially enlarged cross-sectional side view showing a state in which the receiving portion is pressed by the release portion and the engagement between a first lock portion and a panel is released during the process in which the first connector and the second connector are mated together.

FIG. 11 is a cross-sectional plan view showing a state in which, in the process in which the first connector and the second connector are mated together, a pressed portion is pressed by a pressing portion, an extension portion is elastically deformed, and a restricting body portion is positioned to face and be able to come into contact with one surface of the panel.

FIG. 12 is a side view showing a state in which the first connector and the second connector are mated together.

FIG. 13 is a plan view showing a state in which the first connector and the second connector are mated together.

FIG. 14 is a partially enlarged cross-sectional plan view showing a state in which a first mating lock portion and a second mating lock portion are engaged with each other when the first connector and the second connector are in a mated state.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure will be listed and described.

(1) A connector according to the present disclosure is a connector including a first connector and a second connector configured to be mated with the first connector from one surface side of a panel, wherein the first connector includes a restricting portion configured to elastically deform in a direction to come into contact with the one surface during a mating process in which the first connector and the second connector are mated together, and a first mating lock portion formed continuously from the restricting portion, the second connector includes a pressing portion configured to press the restricting portion in the direction to come into contact with the one surface during the mating process, and a lock arm configured to elastically deform and disposed separately from the pressing portion, and the lock arm has a second mating lock portion configured to engage with the first mating lock portion.

The restricting portion is positioned to be pressed by the pressing portion and to be able to come into contact with one surface of the panel during the process in which the first connector and the second connector are mated together, thereby restricting the first connector from becoming detached from the panel. As a result, it is possible to expedite the mating of the first connector and the second connector to proceed. When the pressure of the pressing portion is released and the restricting portion is displaced in the direction of elastic return, the first mating lock portion continuing from the restricting portion is positioned to be able to engage with the second mating lock portion of the lock arm, and the first connector and the second connector are maintained in a mated state. Here, the second mating lock portion is disposed separately from the lock arm and therefore can be formed independently of the shape of the lock arm. As a result, the second mating lock portion can be formed into a shape that can reliably maintain the engagement with the first mating lock portion. In addition, the lock arm has an elastically deformable shape, and therefore, depending on circumstances, such as at the time of maintenance, the lock arm can be elastically deformed to release the engagement between the first mating lock portion and the second mating lock portion, and the first connector and the second connector in a mated state can become detached.

(2) In the connector according to (1) described above, it is preferable that the lock arm extends from another surface side of the panel to the one surface side in a cantilevered manner, the second mating lock portion is disposed at an intermediate portion of the lock arm in a direction in which the lock arm extends, and a free end portion of the lock arm is positioned to face the one surface side.

When detaching the first connector and the second connector in a mated state, the lock arm can be elastically deformed by pressing the free end portion of the lock arm, and the engagement between the first mating lock portion and the second mating lock portion can be released. In particular, the free end portion of the lock arm is positioned to face the one surface side of the panel, and therefore the operation of pressing the free end portion of the lock arm can be performed from the one surface side without hindrance.

(3) In the connector according to (1) or (2) described above, it is preferable that the restricting portion is disposed on the first connector as a pair of restricting portions with a gap therebetween in a direction intersecting a direction in which the first connector and the second connector are mated together, and the first mating lock portion is shaped to span the pair of restricting portions.

Since the first mating lock portion is shaped to span the pair of restricting portions, a predetermined rigidity can be ensured, and the engagement with the second mating lock portion can be maintained more reliably.

(4) In the connector according to any one of (1) to (3) described above, it is preferable that the first mating lock portion and the second mating lock portion are positioned in a non-contact state during the mating process.

With the configuration according to (4) described above, no contact resistance occurs between the first mating lock portion and the second mating lock portion during the process in which the first connector and the second connector are mated together, and the operating force required when bringing the connector into a mated state can be reduced.

### DETAILS OF EMBODIMENTS OF PRESENT DISCLOSURE

Specific examples of the present disclosure will be described below with reference to the drawings. Note that the present invention is not limited to these examples, but is indicated by the scope of the claims, and is intended to include all changes within the meaning and scope equivalent to the scope of the claims.

### First Embodiment

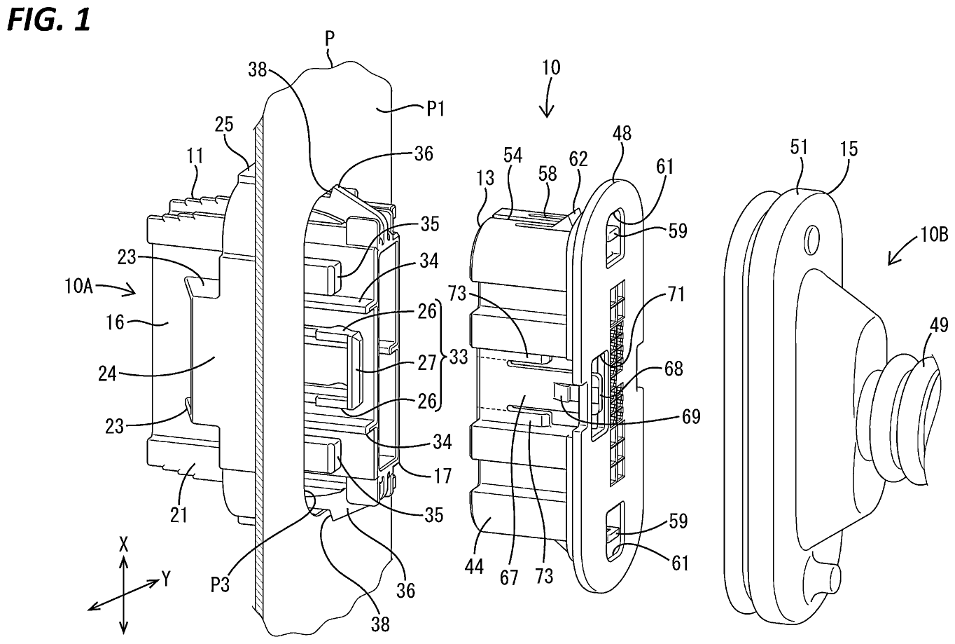

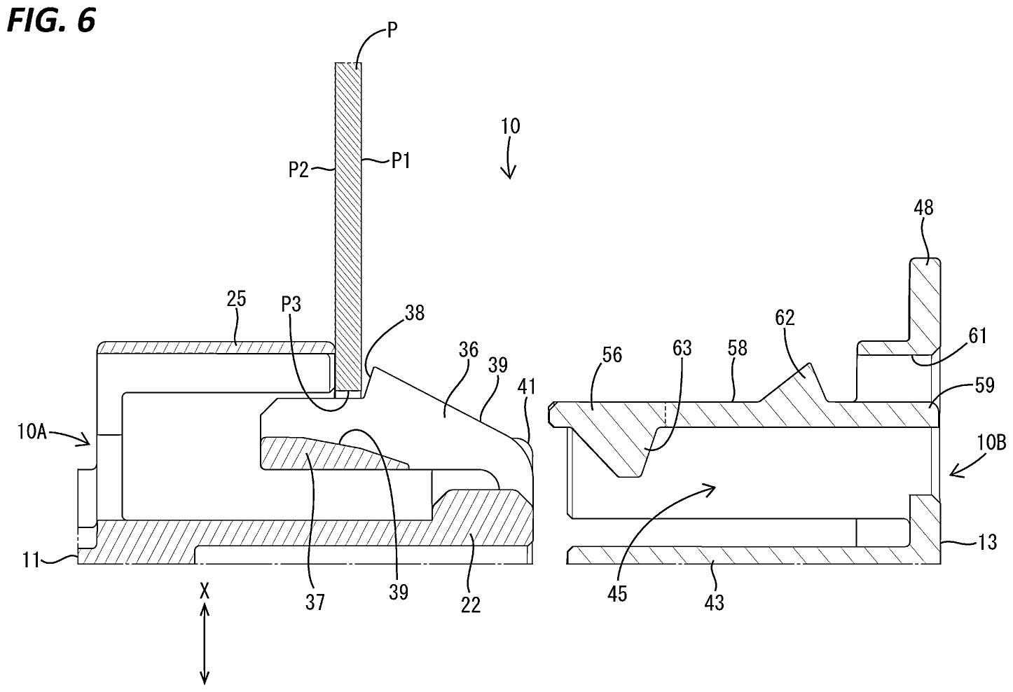

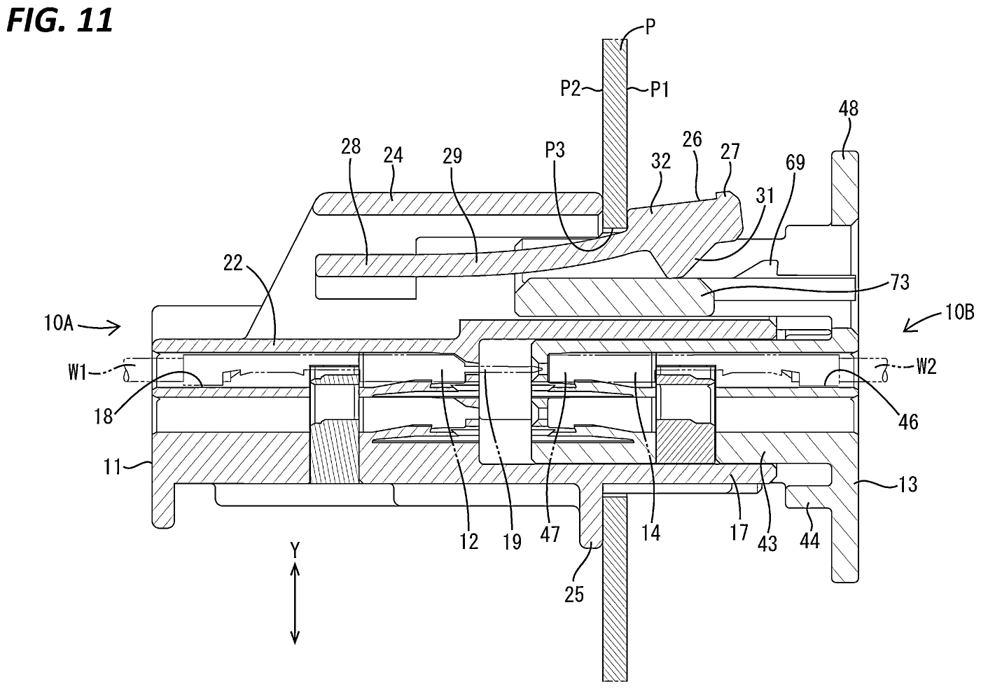

As shown in FIG. 1, a connector 10 according to a first embodiment is a connector that is disposed on a panel P and includes a first connector 10A and a second connector 10B that can be mated with each other. The first connector 10A is a male connector, and is held by the panel P in a standby state before the first connector 10A and the second connector 10B are mated. The first connector 10A includes a first connector housing 11 and first terminal fittings 12 (see FIG. 11). The second connector 10B is a female connector, and is held by the panel P when the first connector 10A and the second connector 10B are in a mated state. The second connector 10B includes a second connector housing 13 and second terminal fittings 14 (see FIG. 11), and a grommet 15. The panel P is, for example, a door panel of a vehicle (not shown), and has a surface defined as one surface P1 facing toward one side in the thickness direction thereof, i.e., the door side (the vehicle exterior side), and a surface defined as the other surface P2 facing toward the other side in the thickness direction, i.e., the body side (the vehicle interior side). As shown in FIG. 6, the panel P has a through hole P3 that passes therethrough from the one surface P1 to the other surface P2. The first connector 10A and the second connector 10B are each held by the panel P in the state of being inserted into the through hole P3. In the following description, with respect to the front-rear direction, the side where each of the first connector 10A and the second connector 10B is mated with the other is referred to as the front side. The top-bottom direction is based on the top-bottom direction in FIG. 1. The top-bottom direction is synonymous with the height direction unless otherwise specified, and is represented by a symbol X in the drawings. The left-right direction is a direction orthogonal to both the front-rear direction and the top-bottom direction. The left-right direction is synonymous with the width direction unless otherwise specified, and is represented by a symbol Y in the drawings. These directional references do not necessarily coincide with directional references when the connector 10 is mounted on a vehicle or the like (not shown).

In addition, in the following description, the side facing toward the center of the connector 10 in the left-right direction is referred to as an inner side in the left-right direction, and the side facing away from the center toward at least one side in the left-right direction is referred to as an outer side in the left-right direction. Similarly, the side facing toward the center of the connector 10 in the top-bottom direction is referred to as an inner side in the top-bottom direction, and the side facing away from the center toward at least one side in the top-bottom direction is referred to as an outer side in the top-bottom direction. In addition, an intermediate portion in the front-rear direction is a portion excluding both ends in the front-rear direction, and is not limited to a central portion in the front-rear direction. Similarly, an intermediate portion in the left-right direction is a portion excluding both ends in the left-right direction, and is not limited to a central portion in the left-right direction, and an intermediate portion in the top-bottom direction is a portion excluding both ends in the top-bottom direction, and is not limited to a central portion in the top-bottom direction.

### (First Connector 10A)

The first connector housing 11 is made of synthetic resin and has an overall shape that is elongated in the top-bottom direction as shown in FIGS. 1 to 3. The first connector housing 11 includes a terminal housing portion 16 and a hood portion 17 that is cylindrical and protrudes forward from the terminal housing portion 16. As shown in FIG. 11, the terminal housing portion 16 has a plurality of first cavities 18. First terminal fittings 12 are inserted into and engaged with the respective first cavities 18 from the rear.

Each first terminal fitting 12 is made of a conductive metal, and as shown in FIG. 11, is connected to a terminal end portion of an electric wire W1. Each first terminal fitting 12 is a male terminal fitting and has a tab 19 protruding forward. Each tab 19 is positioned to protrude toward the inside of the hood portion 17.

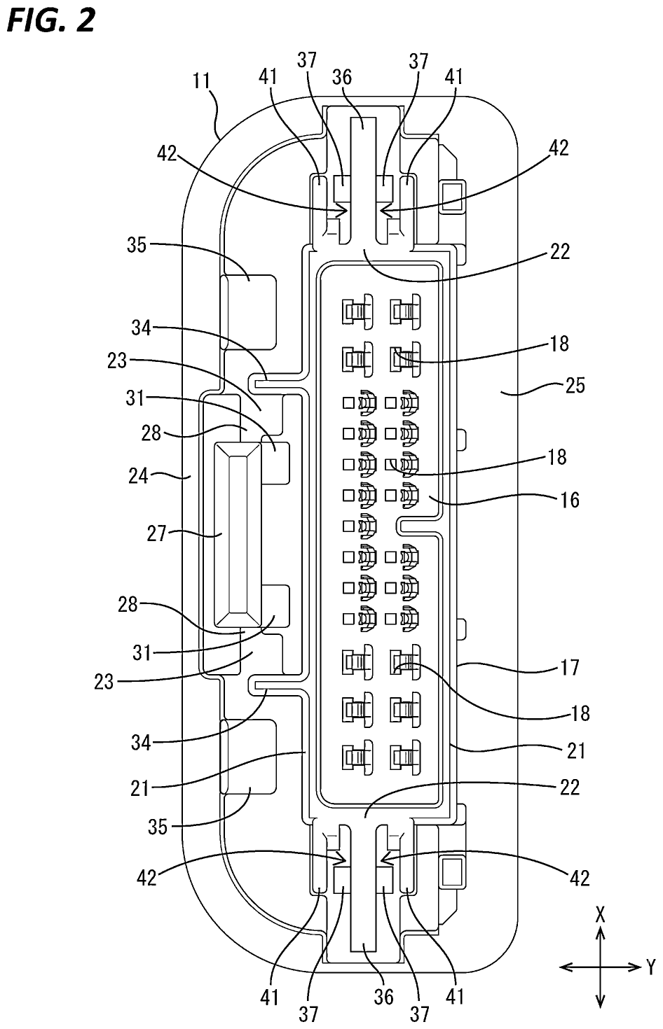

As shown in FIG. 2, the hood portion 17 includes a pair of side walls 21 facing each other in the left-right direction, and a pair of end walls 22 facing each other in the top-bottom direction. The height dimension of each side wall 21 is greater than the width dimension of each end wall 22.

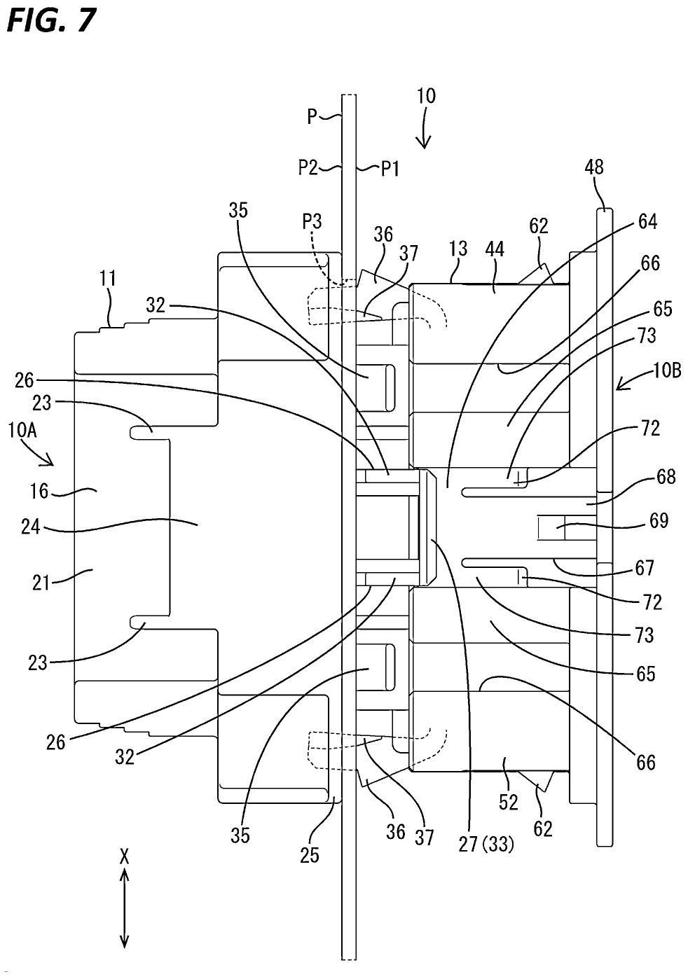

As shown in FIGS. 1 and 7, a pair of facing walls 23 are formed on the outer surface of one side wall 21 of the side walls 21 (the side wall 21 on the near side on the sheets of FIGS. 1 and 7). The facing walls 23 face each other in the top-bottom direction and are disposed in an intermediate portion in the top-bottom direction of the outer surface of one of the side walls 21. In addition, one of the side walls 21 has a covering wall 24 connecting the outer sides in the left-right direction of the facing walls 23 to each other. The front end portion of the covering wall 24 is connected to a first flange portion 25 that surrounds the outer periphery of the hood portion 17. The front surface of the first flange portion 25 is a surface that extends in radial directions of the hood portion 17 and is positioned to face and be able to come into contact with the other surface P2 of the panel P.

As shown in FIG. 7, restricting portions 26 and a first mating lock portion 27 capable of restricting vibration in the top-bottom direction (X direction) are formed on the outer surface side (possibly at a position away from the outer surface) of one of the side walls 21.

The restricting portions 26 are disposed in a pair on the outer surface side of one of the side walls 21 with a gap therebetween in the top-bottom direction. As shown in FIG. 11, each restricting portion 26 has a fulcrum portion 28 located at the rear end, an extension portion 29 extending forward from the fulcrum portion 28, a pressed portion 31 protruding toward the inner side in the left-right direction from the front end side of the extension portion 29, and a restricting body portion 32 protruding toward the outer side in the left-right direction from the front end side of the extension portion 29. The fulcrum portions 28, the extension portions 29, the pressed portions 31, and the restricting body portions 32 are positioned so as to be symmetrically paired in the top-bottom direction on the outer surface side of one of the side walls 21 so as to correspond to the restricting portions 26.

As shown in FIG. 2, each fulcrum portion 28 extends in the top-bottom direction and an outer end portion thereof in the top-bottom direction is connected to the wall surface of the facing wall 23 corresponding thereto. The fulcrum portions 28 are disposed inside the covering wall 24 and are covered by the covering wall 24.

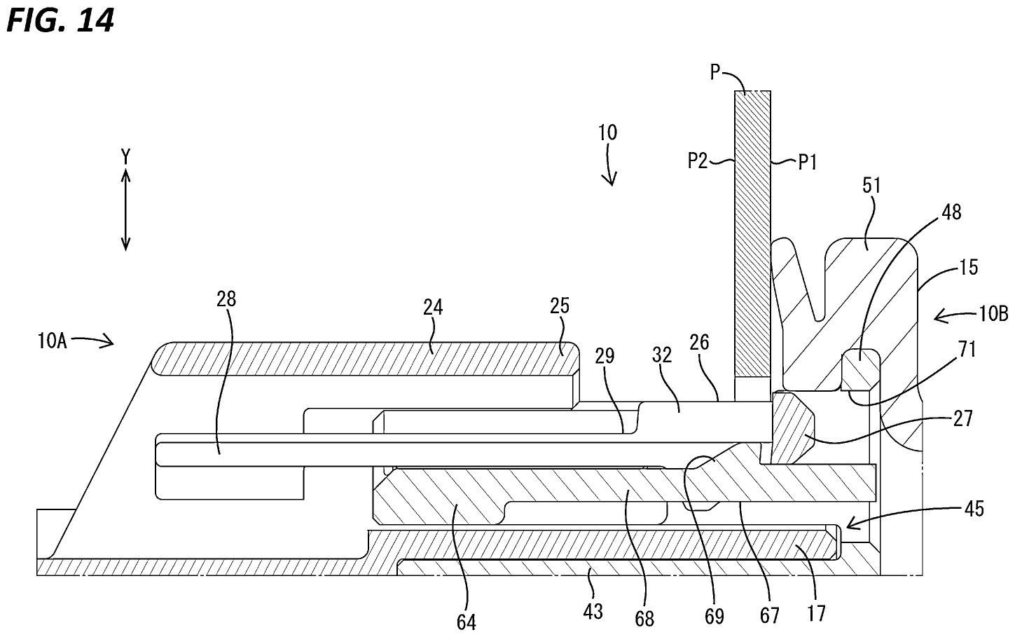

The extension portions 29 each have a plate or rectangular bar shape with the plate surface thereof facing in the top-bottom direction. The rear end portion of each extension portion 29 is connected to the inner end in the top-bottom direction of the fulcrum portion 28 corresponding thereto. As shown in FIG. 14, the rear portion of each extension portion 29 is disposed inside the covering wall 24 and is covered by the covering wall 24. The front portion of each extension portion 29 is disposed so as to be exposed further forward compared to the first flange portion 25.

As shown in FIG. 11, each pressed portion 31 comes into contact with and is pressed by a pressing portion 73 of the second connector housing 13, which will be described later. The front surface of each pressed portion 31 is inclined rearward. The rear surface of each pressed portion 31 is inclined forward. The leading end surface of each pressed portion 31 in the protruding direction is formed so as to be flat in the front-rear direction.

As shown in FIG. 11, each restricting body portion 32 is disposed on the opposite side to the pressed portion 31 corresponding thereto with the extension portion 29 corresponding thereto interposed therebetween. Each restricting body portion 32 has a rectangular plate shape with the plate surface thereof facing in the left-right direction (Y direction). The end surface of each restricting body portion 32 on the outer side in the left-right direction is disposed so as to extend in the front-rear direction. The rear surface of each restricting body portion 32 is disposed so as to extend in the left-right direction. As shown in FIG. 7, the front ends of the restricting body portions 32 are connected to the first mating lock portion 27.

As shown in FIG. 11, when the pressed portions 31 are pressed by the pressing portions 73, the extension portions 29 are elastically deformed toward the outer side in the left-right direction with the fulcrum portions 28 serving as fulcrums. When the extension portions 29 are elastically deformed, the restricting body portions 32 are also displaced toward the outer side in the left-right direction, and the rear surfaces of the restricting body portions 32 are positioned to face the one surface P1 of the panel P.

As shown in FIGS. 1 and 7, the first mating lock portion 27 is formed continuously from each of the restricting portions 26. Specifically, the first mating lock portion 27 has a plate shape extending in the top-bottom direction with the upper end portion thereof connected to the front end of the upper restricting portion 26 and the lower end portion thereof connected to the front end of the lower restricting portion 26. That is to say, the first mating lock portion 27 is shaped to bridge the front ends of the restricting portions 26 to each other.

The first mating lock portion 27 includes portions that protrude further toward the outer side in the left-right direction compared to the restricting body portions 32 and extend in the top-bottom direction. As shown in FIGS. 1 and 2, the upper, lower, left, and right outer peripheral edges of the front surface of the first mating lock portion 27 are tapered toward the front. As shown in FIG. 14, the rear surface of the first mating lock portion 27 is positioned to extend in the top-bottom direction and the left-right direction. As shown in FIG. 1, each of the restricting portions 26 and the first mating lock portion 27 are integrated with each other to form a restricting lock portion 33 having a rectangular frame shape. The restricting lock portion 33 is disposed in an intermediate portion in the top-bottom direction of the outer surface of one of the side walls 21.

As shown in FIGS. 1 and 2, a pair of inner guide ribs 34 are provided so as to protrude from the outer surface of one of the side walls 21 on the two sides of the restricting lock portion 33. Each inner guide rib 34 has a plate shape with the plate surface thereof facing in the top-bottom direction, and extends in the front-rear direction. In addition, a pair of outer guide ribs 35 are formed on the outer surface side of one of the side walls 21 so as to protrude forward from the facing walls 23. The outer guide ribs 35 are prismatic and disposed apart from the outer surface of one of the side walls 21 on the outer side in the left-right direction.

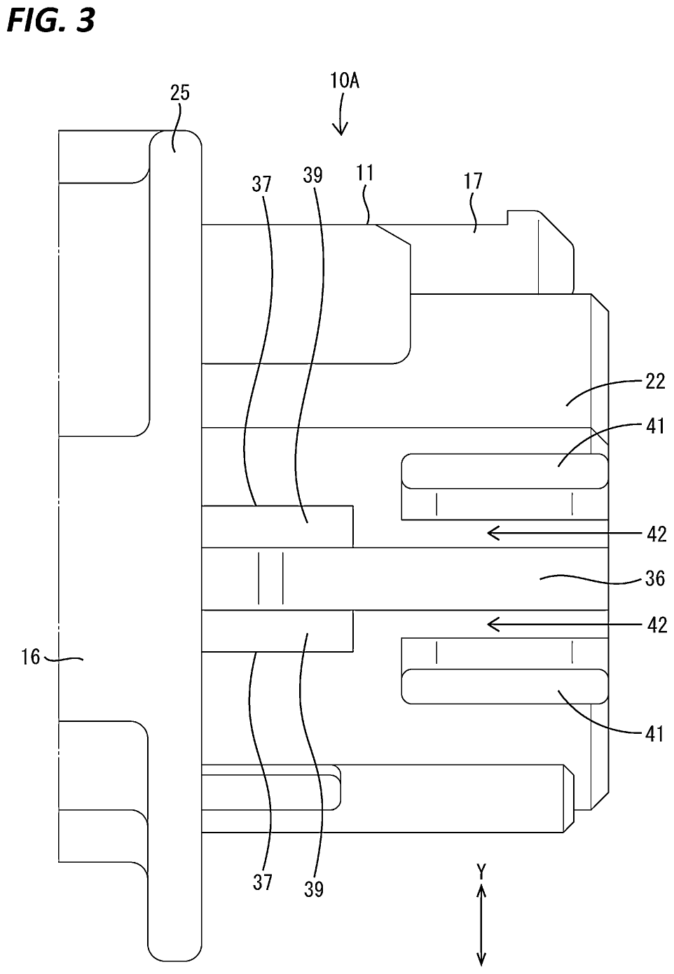

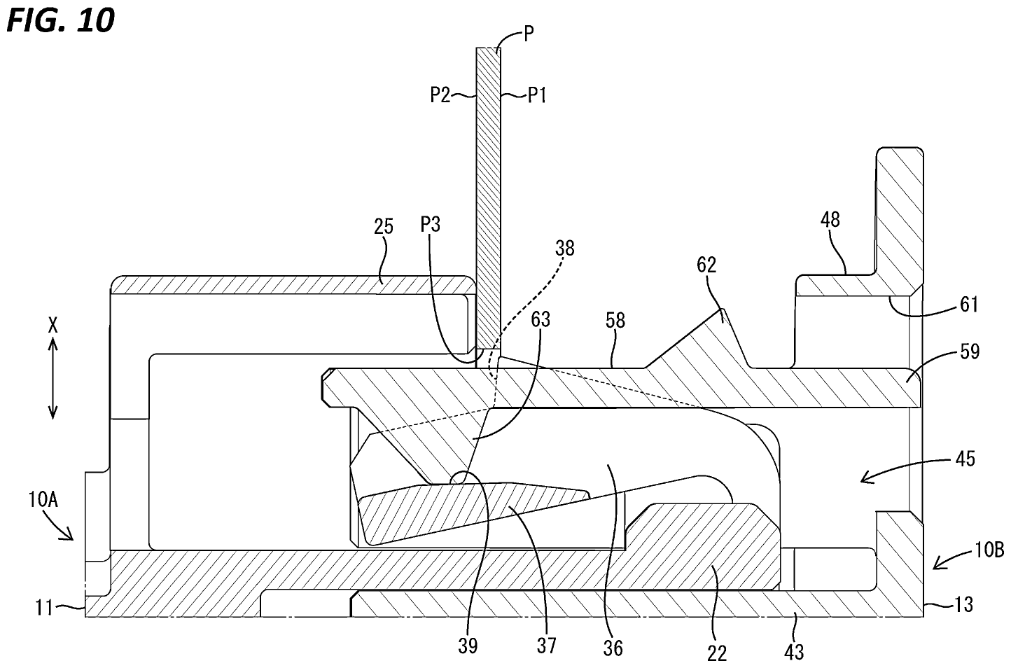

As shown in FIGS. 2 and 3, a first lock portion 36 and receiving portions 37 are formed on the outer surface of each end wall 22. Each first lock portion 36 has a plate shape with the plate surface thereof facing in the left-right direction. The left and right side surfaces (plate surfaces) of each first lock portion 36 are positioned to extend in the top-bottom direction and the left-right direction. Each first lock portion 36 is disposed at an intermediate portion in the left-right direction of the end wall 22 corresponding thereto. As shown in FIG. 6, each first lock portion 36 is formed so as to protrude outward from the front end portion of the outer surface of the end wall 22 corresponding thereto in the outer side in the top-bottom direction and thereafter extend rearward in a cantilevered manner. Each first lock portion 36 is elastically deformable in the top-bottom direction with the front end portion thereof connected to the outer surface of the end wall 22 corresponding thereto serving as a fulcrum (see FIG. 10).

As shown in FIG. 6, the front surface of each first lock portion 36 is inclined rearward, except for the portion rising from the end wall 22. The portion rising from the end wall 22 of the front surface of the first lock portion 36 is positioned to extend in the top-bottom direction. In addition, a panel engaging portion 38 is formed at an intermediate portion in the front-rear direction of the upper and lower outer surfaces of each first lock portion 36. The panel engaging portion 38 is a surface that faces rearward, and is disposed so as to be able to engage with the one surface P1 of the panel P.

Each receiving portion 37 is formed continuously from the first lock portion 36 corresponding thereto. As shown in FIG. 10, each receiving portions 37 is pressed by a release portion 63 of the second connector housing 13, which will be described later, and transmits the pressing force to the first lock portion 36 corresponding thereto, thereby elastically deforming the first lock portion 36. As shown in FIGS. 2 and 3, the receiving portions 37 are provided in pairs on the left and right side surfaces of the first lock portion 36 corresponding thereto so as to protrude therefrom. Specifically, the receiving portions 37 are each rib-shaped and extend in the front-rear direction, and are disposed on the rear portions on the inner side in the top-bottom direction of the left and right side surfaces of the first lock portion 36 corresponding thereto. As shown in FIG. 6, the upper and lower outer surfaces of each receiving portion 37 are formed as sliding surfaces 39 on which the release portions 63 slide. Each sliding surface 39, except for the rear end portion thereof, has a slope shape that is inclined rearward. The rear end portion of the sliding surface 39 is positioned so as to extend in the front-rear direction.

As shown in FIGS. 2 and 3, a pair of protective walls 41 are formed on the outer surface of each end wall 22, on the two sides of the first lock portion 36 corresponding thereto, so as to be spaced apart in the left-right direction from the first lock portion 36. Each protective wall 41 has a rectangular plate shape with the plate surface thereof facing in the left-right direction, and is disposed so as to cover the front end portion of the first lock portion 36 corresponding thereto from the outer side in the left-right direction.

The left and right side surfaces of each protective wall 41 are positioned to extend in the top-bottom direction and the left-right direction. The spaces between the side surface of each protective wall 41 on the inner side in the left-right direction and the side surface of the first lock portion 36 corresponding thereto on the outer side in the left-right direction is formed as an entry space 42 that allows a release portion 63 to enter. The receiving portions 37 are disposed rearward of the entry spaces 42.

### (Second Connector 10B)

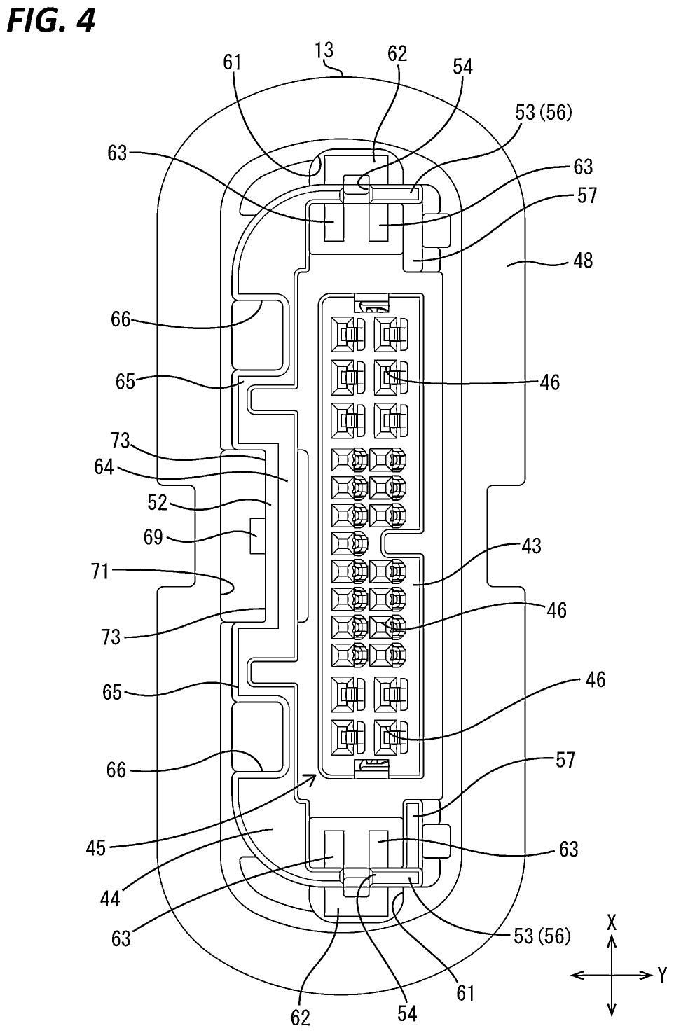

The second connector housing 13 is made of synthetic resin and has an overall shape that is elongated in the top-bottom direction as shown in FIGS. 1, 4, and 5. As shown in FIG. 4, the second connector housing 13 includes a housing body portion 43 and a mating tubular portion 44 surrounding the outer periphery of the housing body portion 43. A mating space 45 is formed between the housing body portion 43 and the mating tubular portion 44 so as to be open forward. The hood portion 17 is fitted into the mating space 45.

The housing body portion 43 has a plurality of second cavities 46. Second terminal fittings 14 are inserted into and engaged with the respective second cavities 46 from the rear.

Each second terminal fitting 14 is made of a conductive metal, and as shown in FIG. 11, is connected to a terminal end portion of an electric wire W2. Each second terminal fitting 14 is a female terminal fitting and has a cylindrical connecting portion 47. When the first connector 10A and the second connector 10B are mated together, the tabs 19 of the first terminal fittings 12 are inserted into the connecting portions 47. The tabs 19 come into contact with the elastic contact portions (not shown) formed inside the connecting portions 47, and accordingly the first terminal fittings 12 and the second terminal fittings 14 are electrically connected.

A second flange portion 48 is formed at the rear end of the second connector housing 13 so as to bulge outward in radial directions. The rear surface of the second flange portion 48 is continuous with the rear surface of the connecting portion connecting the housing body portion 43 and the mating tubular portion 44 so that no step is formed therebetween, and is positioned to extend in radial directions. The grommet 15 is attached to the second flange portion 48.

The grommet 15 is made of rubber and includes a bellows-shaped tube portion 49 and a mounting portion 51 that is widened from the front end of the tube portion 49, as shown in FIG. 1. As shown in FIG. 14, the mounting portion 51 is fitted onto the rear end portion of the second flange portion 48 from behind. The electric wires W2 connected to the second terminal fittings 14 are inserted into the grommet 15 from the mounting portion 51 to the tube portion 49. When the first connector 10A and the second connector 10B are in a mated state, a lip portion of the mounting portion 51 is in close contact with the one surface P1 of the panel P.

As shown in FIG. 4, the mating tubular portion 44 includes a base wall 52 that covers one of the left and right side surfaces of the housing body portion 43 (the left side surface in FIG. 4), and a pair of auxiliary walls 53 that cover the upper and lower end surfaces of the housing body portion 43. The height dimension of the base wall 52 is greater than the width dimension of each auxiliary wall 53.

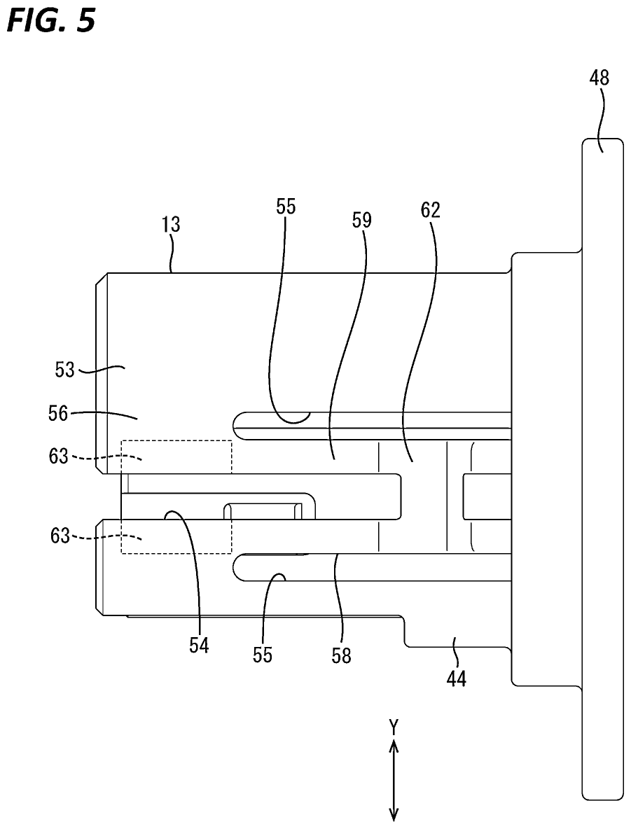

Each auxiliary wall 53 has a groove-shaped recessed portion 54 extending in the front-rear direction. As shown in FIG. 5, the front ends of the recessed portions 54 are open in the front end surfaces of the auxiliary walls 53. The rear end of each recessed portion 54 is closed at a position rearward of the center of the auxiliary wall 53 corresponding thereto in the front-rear direction, inside a second lock portion 58, which will be described later. In addition, in each auxiliary wall 53, a pair of slits 55 are formed on the two sides of the recessed portion 54 so as to be spaced apart from the recessed portion 54 in the left-right direction. The rear end of each slit 55 is open in the rear surface of the second flange portion 48. The front end of each slit 55 is closed at a position forward of the center of the auxiliary wall 53 corresponding thereto in the front-rear direction. The groove width of each slit 55 is smaller than the groove width of each recessed portion 54.

A portion of each auxiliary wall 53 between the front ends of the slits 55 and the front end surface of the auxiliary wall 53 in the front-rear direction is formed as a fixed portion 56 that cannot be elastically deformed. As shown in FIG. 4, one end of each fixed portion 56 in the left-right direction is connected to the base wall 52. The other end of each fixed portion 56 in the left-right direction is connected to a vertical wall 57 that is disposed so as to face the base wall 52 in the left-right direction. As shown in FIG. 5, the front portions of the recessed portions 54 are formed in the fixed portions 56.

Each auxiliary wall 53 has a second lock portion 58 extending rearward from the fixed portion 56 in a cantilevered manner. Each second lock portion 58 includes a plate-shaped lock body portion 59 extending in the width direction and the front-rear direction. The lock body portion 59 defines the end portions of the slits 55 between the slits 55 that are paired in the left and right direction. The rear end of the lock body portion 59 is positioned at the rear end of the second connector housing 13 and faces the rear surface of the second flange portion 48 through an opening 61 formed through the second flange portion 48, as shown in FIGS. 1 and 6.

The rear portion of the recessed portion 54 passes through an intermediate portion in the left-right direction of the lock body portion 59. The lock body portion 59 is elastically deformable in the top-bottom direction with the connecting portion (front end portion) that connects to the fixed portion 56 serving as a fulcrum. In addition, the second lock portion 58 has a lock protrusion 62 that protrudes outward in the top-bottom direction from a rear portion of the lock body portion 59. The lock protrusion 62 is provided on the lock body portion 59 so as to straddle the recessed portion 54. The front surface of the lock protrusion 62 is inclined rearward. The rear surface of the lock protrusion 62 is inclined forward. The lock protrusion 62 is positioned forward of the second flange portion 48.

As shown in FIG. 4, a pair of release portions 63 spaced apart from each other in the left-right direction are formed on the inner surface of each auxiliary wall 53. As shown in FIG. 5, each pair of left and right release portions 63 is disposed adjacent to the recessed portion 54 corresponding thereto, on the two sides of the front portion of the recessed portion 54. As shown in FIG. 6, the release portions 63 are disposed so as to protrude from the fixed portions 56 into the mating spaces 45. As shown in FIG. 4, each release portion 63 has a plate shape with the plate surface thereof facing in the left-right direction.

As shown in FIG. 6, the front surface of each release portion 63 is inclined rearward. The rear surface of the release portion 63 is inclined forward. The leading end surface in the protruding direction (the end surface on the inner side in the top-bottom direction) of each release portion 63 is positioned to extend in the front-rear direction. As shown in FIG. 5, the side surfaces on the inner side in the left-right direction of the release portions 63 are continuous with the inner surfaces of the recessed portions 54 without any step.

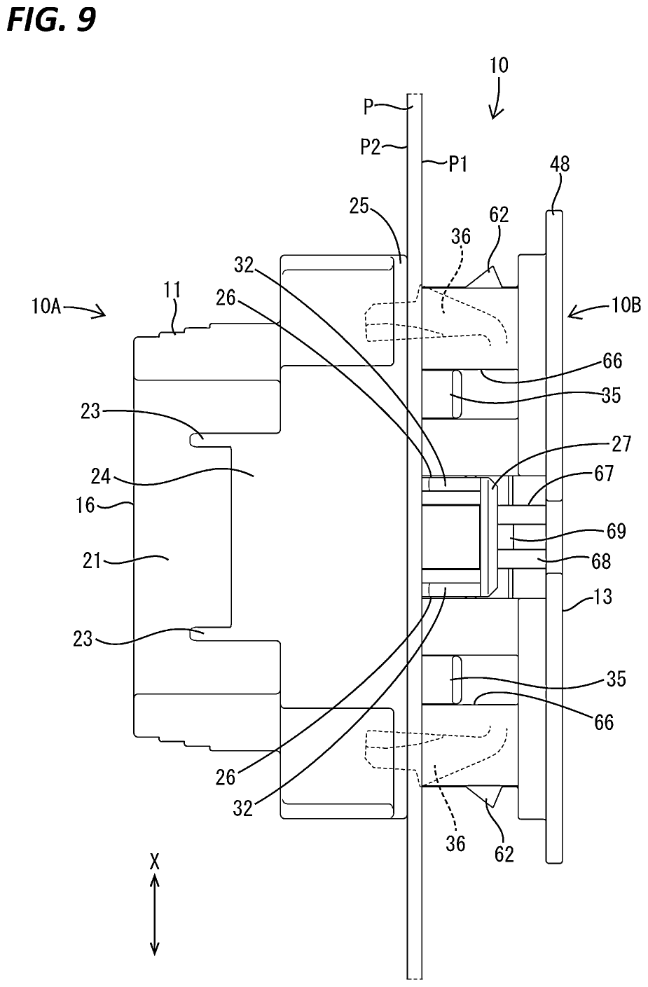

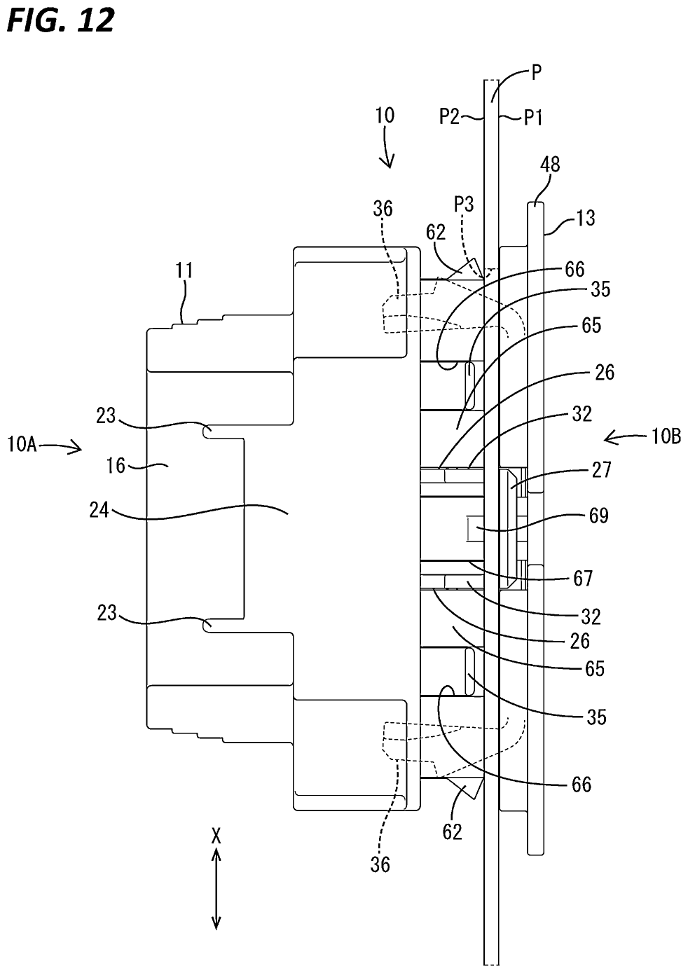

As shown in FIG. 7, a plate-shaped support portion 64 that extends in the top-bottom direction is formed at the front portion of an intermediate portion in the top-bottom direction of the base wall 52. The two end portions in the top-bottom direction of the support portion 64 are connected to a pair of mating guide portions 65 extending in the front-rear direction at an intermediate portion in the top-bottom direction of the base wall 52. As shown in FIG. 4, each mating guide portion 65 has a gate-shaped cross section that opens inward. The inner guide ribs 34 are mated with the mating guide portions 65. A pair of recesses 66 are formed at positions close to the upper and lower end portions of the base wall 52 and adjacent to the mating guide portions 65. Each recess 66 has a gate-shaped cross section that opens outward. As shown in FIGS. 9 and 12, the outer guide ribs 35 are mated with the recesses 66.

As shown in FIGS. 7 and 14, the base wall 52 has a lock arm 67 extending rearward from the support portion 64. The lock arm 67 is elastically deformable in the left-right direction with the connecting portion (front end portion) that connects to the support portion 64 serving as a fulcrum. The lock arm 67 includes an arm body portion 68 that has a rectangular plate shape when viewed from the side, and a second mating lock portion 69 that protrudes from the outer surface of the rear portion of the arm body portion 68. As shown in FIGS. 1 and 14, the rear end of the arm body portion 68 is positioned at the rear end of the second connector housing 13 and faces the rear surface of the second flange portion 48 through a hole 71 formed through the second flange portion 48.

The second mating lock portion 69 is disposed forward of the second flange portion 48. As shown in FIG. 14, the front surface of the second mating lock portion 69 is inclined rearward. The rear surface of the second mating lock portion 69 is positioned to extend in the left-right direction or is slightly inclined rearward with respect to the left-right direction.

As shown in FIG. 7, the base wall 52 has a pair of pressing body portions 72 arranged on the two sides of the lock arm 67 and spaced apart from the lock arm 67 on the outer sides in the top-bottom direction. The pressing body portions 72 each have a rib shape with a rectangular cross section extending rearward from the support portion 64, and the upper and lower ends are connected to the mating guide portions 65 over the entire length in the extension direction. As shown in FIGS. 1 and 7, the portions extending from the pressing body portions 72 to the upper and lower end portions of the support portion 64 are formed as the pressing portion 73 that is not elastically deformable and extends in the front-rear direction. The outer surface of each pressing portion 73 is positioned to extend in the front-rear and top-bottom directions, and is continuous without any step with the outer surface of the support portion 64 other than the pressing portion 73 and the outer surface of the arm body portion 68. In addition, the outer surfaces of the pressing portions 73 intersect with the inner side surfaces in the top-bottom direction of the adjacent mating guide portions 65 at right angles.

### (Functions of Connector 10)

Before the first connector 10A and the second connector 10B are mated together, the first connector housing 11 is inserted into the through hole P3 of the panel P. During the process of inserting the first connector housing 11, the front surface of each first lock portion 36 slides along the hole surface of the through hole P3 of the panel P, and each first lock portion 36 elastically deforms toward the inner side in the top-bottom direction. Thereafter, each first lock portion 36 elastically returns to its original position, and as shown in FIG. 1, the panel engaging portion 38 of each first lock portion 36 is positioned to face and be able to come into contact with the opening edge portion of the through hole P3 in the one surface P1 of the panel P. As shown in FIG. 7, the first flange portion 25 is positioned to face and be able to come into contact with the other surface P2 of the panel P. As a result, the first connector housing 11 is held in a standby state on the panel P, and is restricted from slipping off the panel P in the front-rear direction. The panel P is positioned to be sandwiched between the first lock portions 36 and the first flange portion 25. Note that the front portion of the restricting lock portion 33 passes through the through hole P3 without interfering with the panel P, and is positioned on the one surface P1 side of the panel P.

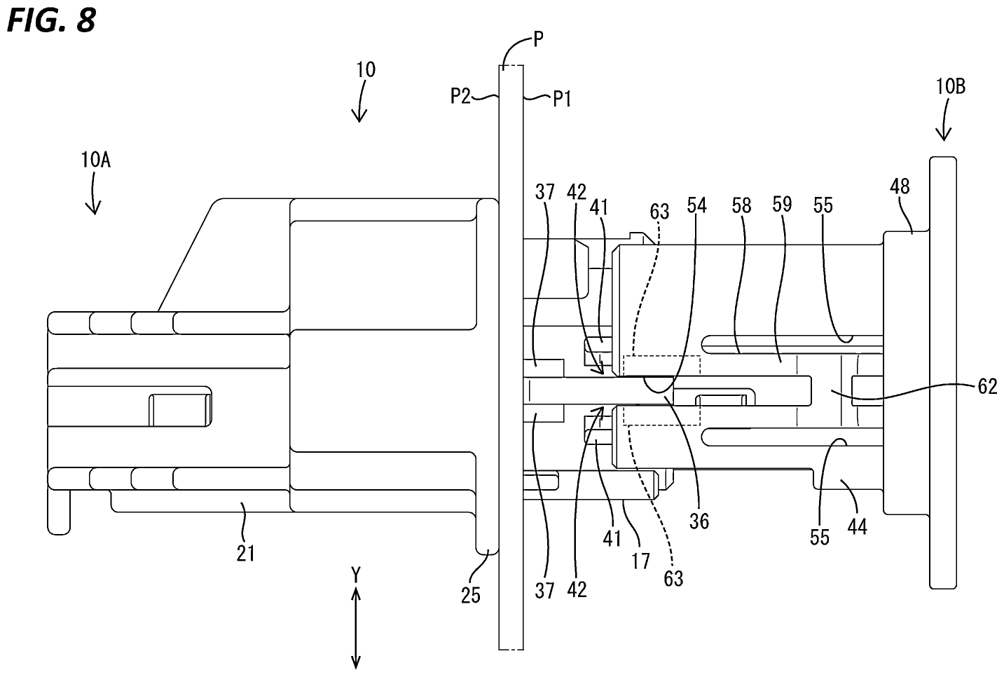

Subsequently, the second connector housing 13 is shallowly mated with the hood portion 17 of the first connector housing 11 from the one surface P1 side of the panel P, and the mating operation of the first connector 10A and the second connector 10B is started. At this time, the inner guide ribs 34 are mated with the mating guide portions 65 (see FIG. 7), and the release portions 63 are mated with the entry spaces 42 (see FIG. 8). As a result, the first connector 10A and the second connector 10B are prevented from erroneously mated together, and the mating operation of the first connector 10A and the second connector 10B can be guided in the front-rear direction. When the mating operation of the first connector 10A and the second connector 10B begins, portions of the front surfaces of the pressed portions 31 climb onto the outer surfaces on the support portion 64 side of the pressing portions 73, and the extension portions 29 of the restricting lock portion 33 begins to elastically deform outward in the left-right direction. The release portions 63 are still spaced apart from the receiving portions 37, and the first lock portions 36 remain capable of being engaged with the one surface P1 of the panel P.

When the first connector 10A and the second connector 10B are in the mating process where the mating operation of the first connector 10A and the second connector 10B has progressed from the state at the start of mating as described above, the leading end surfaces in the protruding direction of the pressed portions 31 climb onto the upper surfaces of the portions of the pressing portions 73 that extend from the support portion 64 side to the pressing body portions 72 side, and the extension portions 29 of the restricting lock portion 33 elastically deform significantly to the outer side in the left-right direction as shown in FIG. 11. As a result, the restricting body portions 32 face and be able to come into contact with the one surface P1 of the panel P, and the first connector housing 11 is restricted from slipping off the panel P. At this time, the first mating lock portion 27 and the second mating lock portion 69 are positioned in a non-contact state, and the lock arm 67 is maintained in a natural state without elastic deformation. In addition, as shown in FIG. 10, the release portions 63 slide on the sliding surfaces 39 of the receiving portions 37, and the first lock portions 36 integrated with the receiving portions 37 elastically deform toward the inner side in the top-bottom direction, and the panel engaging portions 38 of the first lock portions 36 move away from the opening edge of the through hole P3. In this way, the engagement of the first lock portions 36 with the one surface P1 of the panel P is released, with the restricting portions 26 facing and being able to come into contact with the one surface P1 of the panel P.

In the case of the first embodiment, a pair of receiving portions 37 are disposed on the left and right sides of each first lock portion 36, and a pair of release portions 63 are disposed corresponding to each pair of receiving portions 37. Therefore, equal forces are applied to the first lock portions 36 from the receiving portions 37 on the left and right sides in the direction of releasing engagement with the panel P, allowing the first lock portions 36 to elastically deform smoothly without twisting.

Thereafter, the lock protrusions 62 of the second lock portions 58 slide along the hole surface of the panel P, and the lock body portions 59 of the second lock portion 58 elastically deform toward the inner side in the top-bottom direction. Furthermore, as the mating of the first connector 10A and the second connector 10B progresses, the lock body portions 59 of the second lock portions 58 elastically return to their original state, and as shown in FIG. 12, the lock protrusions 62 of the second lock portions 58 are positioned to face and able to come into contact with the opening edge portion of the through hole P3 in the other surface P2 of the panel P. In addition, the second flange portion 48 is positioned to face and be able to come into contact with the one surface P1 of the panel P. As a result, the second connector housing 13 is held on the panel P, and is restricted from slipping off the panel P in the front-rear direction. The panel P is positioned to be sandwiched between the second lock portions 58 and the second flange portion 48. The release portions 63 are in contact with the rear end portions (the rear end portion when viewed from the first connector 10A) of the sliding surfaces 39 of the receiving portions 37, and the first lock portions 36 are maintained in a state in which they are elastically deformed toward the inner side in the top-bottom direction (see FIG. 14).

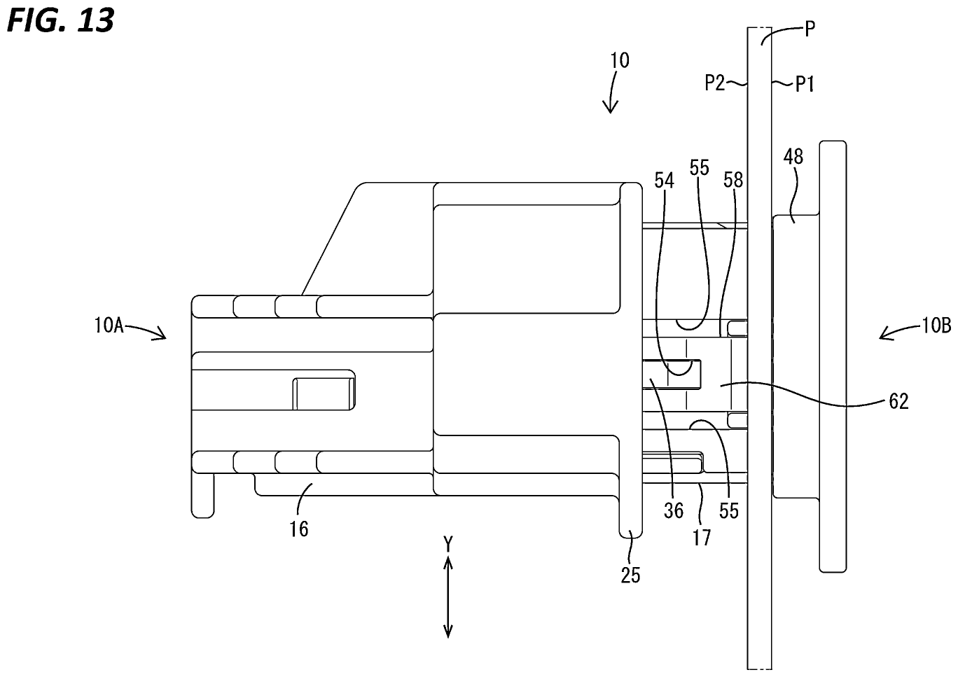

As a result of the above, at the same time that the second lock portions 58 are positioned to be able to engage with the panel P, or immediately after the second lock portions 58 are positioned to be able to engage with the panel P, the pressed portions 31 of the restricting lock portions 33 get over (move past) the upper surfaces on the pressing body portions 72 side of the pressing portions 73, and as a result, the extension portions 29 elastically return to their original position toward the inner side in the left-right direction. As a result of the extension portions 29 elastically returning to their original positions, the first mating lock portion 27 formed continuously from the extension portions 29 is also displaced toward the inner side in the top-bottom direction, and as shown in FIG. 13, the rear surfaces of the first mating lock portion 27 and the second mating lock portion 69 (the rear surfaces when viewed from each of the first connector 10A and the second connector 10B) are positioned to face and be able to come into contact with each other. As shown in FIG. 12, the first mating lock portion 27 is positioned on the one surface P1 of the panel P, and is fitted between the mating guide portions 65 paired in the top-bottom direction. In this way, the first mating lock portion 27 and the second mating lock portion 69 are positioned to be able to engage with each other, thereby maintaining the first connector 10A and the second connector 10B in a mated state.

To detach the first connector 10A and the second connector 10B in the mated state for maintenance or other reasons, first the grommet 15 is removed from the second flange portion 48, and then the leading end portion of a jig or finger (not shown) is pressed against the rear end portion of the lock body portions 59 of the second lock portions 58 through the opening 61 to elastically deform the lock body portions 59 of the second lock portions 58 toward the inner side in the top-bottom direction. As a result, engagement of the lock protrusions 62 and the panel P is released, and the first connector housing 11 and the second connector housing 13, which are in a mated state, are removed from the panel P. Thereafter, the leading end of the jig or finger (not shown) is pressed against the rear end portion of the arm body portion 68 of the lock arm 67 through the hole 71 to elastically deform the arm body portion 68 toward the inner side in the left-right direction. As a result, the second mating lock portion 69 is separated from the first mating lock portion 27, and engagement between the first mating lock portion 27 and the second mating lock portion 69 is released. In this state, by pulling the first connector 10A and the second connector 10B apart, the first connector 10A and the second connector 10B become detached from each other.

As described above, a connector 10 according to the first embodiment includes: a first connector 10A; and a second connector 10B configured to be mated with the first connector 10A from one surface P1 side of a panel P. The first connector 10A includes restricting portions 26 configured to elastically deform in a direction to come into contact with the one surface P1 of the panel P during the process in which the first connector 10A and the second connector 10B are mated together, and a first mating lock portion 27 formed continuously from the restricting portions 26. The second connector 10B includes pressing portions 73 configured to press the restricting portions 26 in the direction to come into contact with the one surface P1 of the panel P during the mating process, and a lock arm 67 configured to elastically deform and disposed separately from the pressing portions 73. The lock arm 67 has a second mating lock portion 69 configured to engage with the first mating lock portion 27.

In the process in which the first connector 10A and the second connector 10B are mated together, the restricting portions 26 are pressed by the pressing portions 73 and positioned to be able to come into contact with the one surface P1 of the panel P, thereby restricting the first connector 10A from becoming detached from the panel P. As a result, it is possible to expedite the mating of the first connector 10A and the second connector 10B. When the pressure of the pressing portions 73 is released and the restricting portions 26 are displaced in the direction of elastic return, the first mating lock portion 27 continuing from the restricting portions 26 is positioned to be able to engage with the second mating lock portion 69 of the lock arm 67, and the first connector 10A and the second connector 10B are maintained in a mated state. Here, the second mating lock portion 69 is disposed separately from the lock arm 67 and therefore can be formed independently of the shape of the lock arm 67. As a result, the second mating lock portion 69 can be formed into a shape that can reliably maintain the engagement with the first mating lock portion 27. In addition, the lock arm 67 has an elastically deformable shape, and therefore, depending on circumstances, such as at the time of maintenance, the lock arm 67 can be elastically deformed to release the engagement between the first mating lock portion 27 and the second mating lock portion 69, and the first connector 10A and the second connector 10B in a mated state can become detached.

In addition, the lock arm 67 extends from another surface P2 side of the panel P to the one surface P1 side (rear side) in a cantilevered manner, the second mating lock portion 69 is positioned at an intermediate portion in the front-rear direction of the lock arm 67, and the rear end portion (free end portion) of the lock arm 67 is positioned to face the one surface P1 side of the panel P.

When detaching the first connector 10A and the second connector 10B in the mated state, the lock arm 67 can be elastically deformed by pressing the rear end portion of the lock arm 67, and the engagement between the first mating lock portion 27 and the second mating lock portion 69 can be released. In particular, the rear end portion of the lock arm 67 is positioned to face the one surface P1 side of the panel P, and therefore the operation of pressing the rear end portion of the lock arm 67 can be performed from the one surface P1 side of the panel P without hindrance.

In addition, the restricting portions 26 are disposed on the first connector 10A as a pair of restricting portions 26 with a gap therebetween in a direction (top-bottom direction) intersecting a direction in which the first connector 10A and the second connector 10B are mated together, and the first mating lock portion 27 is shaped to span the pair of restricting portions 26. Since the first mating lock portion 27 is shaped to span the pair of restricting portions 26, a predetermined rigidity can be ensured, and the engagement with the second mating lock portion 69 can be maintained more reliably.

In addition, the first mating lock portion 27 and the second mating lock portion 69 are positioned in a non-contact state during the process in which the first connector 10A and the second connector 10B are mated together. Therefore, no contact resistance occurs between the first mating lock portion 27 and the second mating lock portion 69, and the operating force required when bringing the connector 10 into a mated state can be reduced.

Furthermore, in the case of the connector 10 according to the first embodiment, the first connector 10A includes first lock portions 36 that are to be engaged with the panel P and are elastically deformable, and receiving portions 37 formed continuously from the first lock portions 36. The second connector 10B includes release portions 63 that press the receiving portions 37 in the process in which the first connector 10A and the second connector 10B are mated together, so that engagement of the first lock portions 36 with the panel P is released, and second lock portions 58 that are elastically deformable and are to be engaged with the panel P when the first connector 10A and the second connector 10B are in a mated state. The receiving portions 37 are disposed in pairs, each pair being on the two sides of the first lock portion 36 corresponding thereto. The release portions 63 correspond to the pairs of receiving portions 37 and are disposed in pairs, each pair being on the two sides of the second lock portion 58 corresponding thereto.

In the process in which the first connector 10A and the second connector 10B are mated together, the receiving portions 37 disposed in a pair on the two sides of each first lock portion 36 are pressed by the release portions 63 corresponding thereto, so that equal forces can be applied to each first lock portion 36 from the two sides thereof in the direction of disengagement. As a result, when the first lock portions 36 are released from the engagement with the panel P, they can be smoothly elastically deformed.

In addition, each second lock portion 58 includes a plate-shaped lock body portion 59 whose plate width extends in the left-right direction. An intermediate portion in the left-right direction of the lock body portion 59 is provided with a recessed portion 54 that extends in the front-rear direction and opens in the front end thereof. The first lock portions 36 are shaped to mate with the recessed portions 54.

Since the first lock portions 36 can be mated with the recessed portions 54 formed in the intermediate portions of the lock body portions 59 in the left-right direction, the above-described structure in which the receiving portions 37 are disposed on both left and right sides of each first lock portion 36 and the release portions 63 are disposed on both left and right sides of each second lock portion 58 can be realized in an efficient and space-saving way. In addition, as a result of the first lock portions 36 being mated with the recessed portions 54, the bending movement of each second lock portion 58 is guided.

In addition, each pair of left and right release portions 63 is disposed adjacent to the recessed portion 54 corresponding thereto, on both left and right sides of the recessed portion 54. Therefore, the above-described structure in which receiving portions 37 are disposed on both left and right sides of each first lock portion 36 and release portions 63 are disposed on both left and right sides of each second lock portion 58 can be realized with greater space efficiency while suppressing an increase in the size of the connector 10.

In addition, the first connector 10A includes protective walls 41 disposed on the two sides of each first lock portion 36 and spaced apart from the first lock portion 36 in the left-right direction. The spaces between the protective walls 41 and the first lock portion 36 corresponding thereto are formed as entry spaces 42 that allow the release portions 63 corresponding thereto to enter.

Therefore, the first lock portions 36 are protected from external foreign objects by the protective walls 41. In addition, since the spaces between the protective walls 41 and the first lock portions 36 are the entry spaces 42 that allow the release portions 63 to enter, the increase in size of the connector 10 can be more effectively suppressed.

### Other Embodiments of Present Disclosure

The embodiments disclosed herein should be considered to be illustrative in all respects and not restrictive.

In the case of the first embodiment described above, the first connector 10A includes restricting portions 26 and a first mating lock portion 27 on a side walls 21, and includes a first lock portion 36 and receiving portions 37 on each end wall 22. In addition, the second connector 10B includes a lock arm 67 and a pressing portion 73 on a base wall 52, and includes a second lock portion 58 and release portions 63 on each auxiliary wall 53. In contrast, in another embodiment, contrary to the first embodiment, the first connector may have a restricting portion and a first mating lock portion on an end wall, and a first lock portion and a receiving portion on a side wall. In addition, the second connector may include a lock arm and a pressing portion on an auxiliary wall, and a second lock portion and a release portion on a base wall.

In the first embodiment described above, the first connector 10A includes a male-type first connector housing 11 and male-type first terminal fittings 12, and the second connector 10B includes a female-type second connector housing 13 and female-type second terminal fittings 14. In contrast, in another embodiment, contrary to the first embodiment, the first connector may include a female-type first connector housing and female-type first terminal fittings, and the second connector may include a male-type second connector housing and male-type second terminal fittings.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector comprising
a first connector and a second connector configured to be mated with the first connector from one surface side of a panel,
wherein the first connector includes a restricting portion configured to elastically deform in a direction to come into contact with the one surface during a mating process in which the first connector and the second connector are mated together, and a first mating lock portion formed continuously from the restricting portion,
the second connector includes a pressing portion configured to press the restricting portion in the direction to come into contact with the one surface during the mating process, and a lock arm configured to elastically deform and disposed separately from the pressing portion, and
the lock arm has a second mating lock portion configured to engage with the first mating lock portion.

2. The connector according to claim 1,
wherein the lock arm extends from another surface side of the panel to the one surface side in a cantilevered manner,
the second mating lock portion is disposed at an intermediate portion of the lock arm in a direction in which the lock arm extends, and
a free end portion of the lock arm is positioned to face the one surface side.

3. The connector according to claim 1,
wherein the restricting portion is disposed on the first connector as a pair of restricting portions with a gap therebetween in a direction intersecting a direction in which the first connector and the second connector are mated together, and
the first mating lock portion is shaped to span the pair of restricting portions.

4. The connector according to claim 1,
wherein the first mating lock portion and the second mating lock portion are positioned in a non-contact state during the mating process.
